(19) United States
(12) Patent Application Publication
(10) Pub. No.: US 2008/0068758 A1
(43) Pub. Date: Mar. 20, 2008

(54) Reduction of electrostatic charges in hard disk drives

(75) Inventor: Dongman Kim, Campbell, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/523,907

(22) Filed: Sep. 19, 2006

(51) Int. Cl. G11B 5/55

(52) U.S. Cl. 360/265.7

(57) ABSTRACT

A hard disk drive with an actuator arm that discharges static charge from a disk. The actuator arm may be constructed from a corona discharger and/or a Polonium 210 or Americium 241 material that discharges static charge as the arm is moved across a disk. The disk is typically discharged before any read/write operation of the drive.

### BACKGROUND OF THE INVENTION

1. Field of the Invention

The present invention relates to discharging static charge on a disk of a hard disk drive.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element for magnetizing the disks and a separate read element for sensing the magnetic fields of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is attached to a suspension arm to create an subassembly commonly referred to as a head gimbal assembly (“HGA”). The HGA's are attached to an actuator arm which has a voice coil motor that can move the heads across the surfaces of the disks.

The disks may retain a static charge that can discharge and cause damage to the disk drive. For example, an electrostatic discharge (“ESD”) may cause arcing with the drive heads, that may vary the flying height of a head due to columbic forces, and cause electro-galvanic corrosion of disk asperities and/or the attraction and collection of disk lubricants under the heads. The static charge may be created during the parking of the heads, or other ramp down operations as well as spindle operations.

There have been various attempts to minimize static charge. For example, anti-static material is sometimes coated onto the disks and/or slider. Additionally, attempts have been made to eliminate static discharge by controlling the humidity within the disk drive cavity. These approaches complicate the manufacturing process and/or operation of the drive. It would be desirable to provide a way to discharge static charges on the disks without adding parts or complexity to present disk drives.

### BRIEF SUMMARY OF THE INVENTION

A hard disk drive with an actuator arm that discharges static charge in a disk of the drive.

### BRIEF DESCRIPTION OF THE DRAWINGS

FIG. 1 is a top view of an embodiment of a hard disk drive;

FIG. 2 is a top enlarged view of a head of the hard disk drive;

FIG. 3 is a schematic of an electrical system of the hard disk drive.

### DETAILED DESCRIPTION

Disclosed is a hard disk drive with an actuator arm that discharges static charge from a disk. The actuator arm may be constructed from a corona discharger and/or a material that discharges static charge as the arm is moved across a disk. The disk is typically discharged before any read/write operation of the drive.

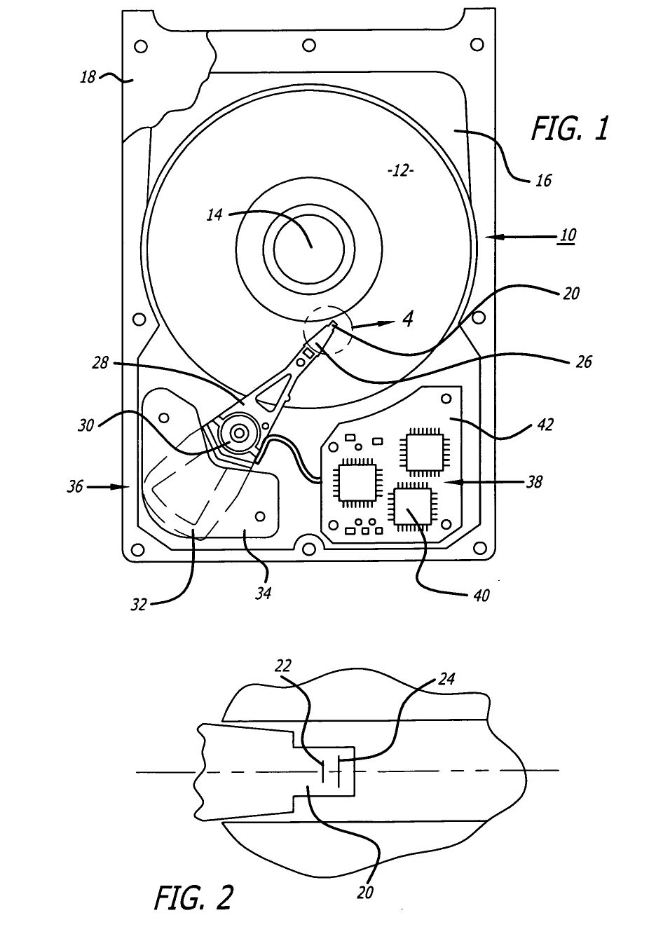

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 2 the heads 20 may have separate write 24 and read elements 22. The write element 24 magnetizes the disk 12 to write data. The read element 22 senses the magnetic fields of the disks 12 to read data. By way of example, the read element 22 may be constructed from a magneto-resistive material that has a resistance which varies linearly with changes in magnetic flux.

Each head 20 may be gimbal mounted to a suspension arm 26. The suspension arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 42 is coupled to the voice coil 32, heads 20 and spindle motor 14 by wires (not shown).

The actuator arm 28 is constructed to discharge any static charge on the disk 12. By way of example, the actuator arm 28 may be constructed to contain Polonium 210 (Po-210) or Americium 241 (Am-241) which has other properties desirable for use as an actuator arm. The actuator arm 28 has an electrical potential so that the arm 28 discharges static charge when moved adjacent to the disk 12. The actuator arm 28 may be constructed to be a corona discharger that removes charge under the corona charge phenomenon.

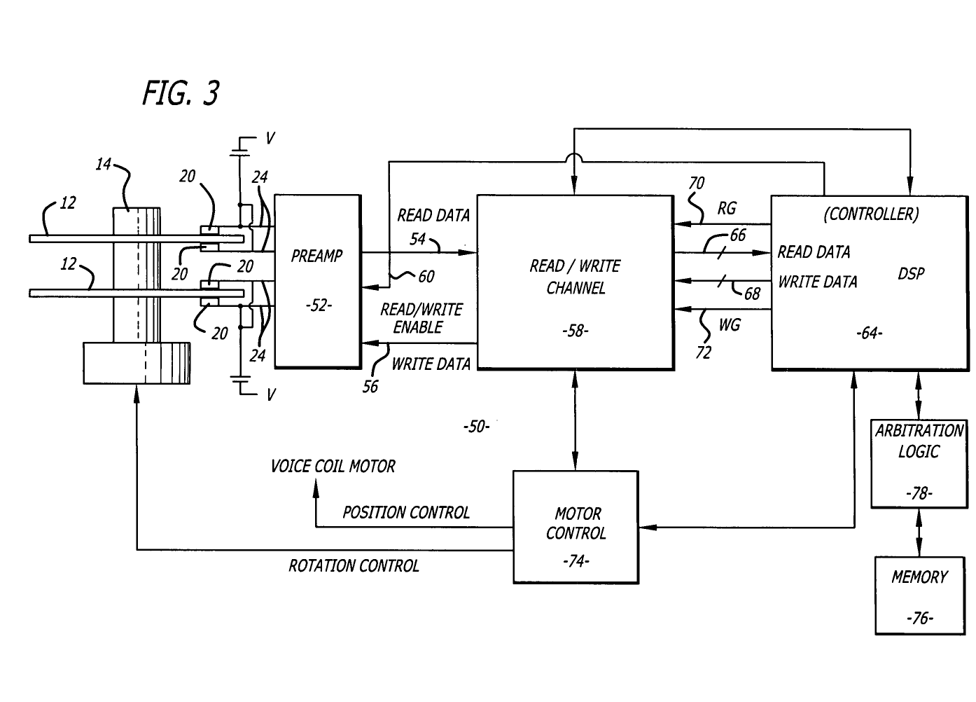

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a memory device 76. By way of example, the device 76 may contain instructions that are read by the controller 64.

The actuator arms 28 are shown connected to a voltage source to create a voltage potential between the arms 28 and the disk. The voltage potential discharges static charge from the disks. The voltage potential may be ground.

The controller 64 may cause the actuator arms 24 to move across the disk 12 to discharge static charge before commencing any read or write operations. In this manner the disk is statically discharged before operation of the disk drive to insure that a static discharge does not damage the electrical circuits of the drive. The voltage potential on the actuator arms may be terminated when the drive is performing read and write operations.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a base plate;
a spindle motor coupled to said base plate;
a disk coupled to said spindle motor, said disk containing a static charge;
an actuator arm mounted to said base plate;
a voice coil motor coupled to said actuator arm, said voice coil motor moves said actuator arm across said disk, said actuator arm discharges the static charge on said disk;
a head coupled to said actuator arm and said disk; and,
a control circuit that controls said voice coil motor, said spindle motor and said head.

2. The hard disk drive of claim 1, wherein said actuator arm includes a corona discharger.

3. The hard disk drive of claim 1, wherein said actuator arm contains polomium and beryllium.

4. The hard disk drive of claim 1, wherein said control circuit moves said actuator arm across said disk to discharge the static charge before initiating a read/write operation.

5. A hard disk drive, comprising:
a base plate;
a spindle motor coupled to said base plate;
a disk coupled to said spindle motor, said disk containing a static charge;
an actuator arm mounted to said base plate, said actuator arm having means for discharging the static charge;
a voice coil motor coupled to said actuator arm;
a head coupled to said actuator arm and said disk; and,
a control circuit that controls said voice coil motor, said spindle motor and said head.

6. The hard disk drive of claim 5, wherein said actuator arm means includes a corona discharger.

7. The hard disk drive of claim 5, wherein said actuator arm means contains polomium and beryllium.

8. The hard disk drive of claim 5, wherein said actuator arm means discharges the static charge before a read/write operation of the hard disk drive.

9. A method for discharging a static charge on a disk of a hard disk drive, comprising:
moving an actuator arm adjacent to the disk so that the actuator arm discharges the static charge.

10. The method of claim 9, wherein the static charge is discharged before a read/write operation.

11. The method of claim 9, wherein the actuator functions as a corona discharger.

12. The method of claim 9, wherein the actuator arm contains Polonium 210 or Americium 241.
